(19) United States
(12) Patent Application Publication
(10) Pub. No.: US 2023/0092301 A1
(43) Pub. Date: Mar. 23, 2023

(54) SYSTEM AND METHOD FOR BROADBAND SERVICES USING FREE-SPACE OPTICAL LINKS

(71) Applicants: Douglas Garth Burr, Kent, WA (US); Walter Saul Gelon, Sunnyvale, CA (US)

(72) Inventors: Douglas Garth Burr, Kent, WA (US); Walter Saul Gelon, Sunnyvale, CA (US)

(21) Appl. No.: 17/942,883

(22) Filed: Sep. 12, 2022

Related U.S. Application Data
(60) Provisional application No. 63/246,473, filed on Sep. 21, 2021.

(51) Int. Cl. H04B 10/112

(52) U.S. Cl. CPC H04B 10/1123; H04B 10/1129

(57) ABSTRACT

A system and method for providing terrestrial and planetary point-to-point, high-altitude platform, and satellite broadband data services by using free-space optical communications link in conjunction with a high-data-rate wideband frequency modulation waveform. The architecture supports data capacities greater than an order of magnitude over the most capable current terrestrial, satellite constellation, and outer space communication systems. The optical links use optical wideband frequency modulation permitting compact optical terminals and avoidance of cost- and mass-intensive digital processing in the communication chain. For terrestrial applications, provided are high-altitude relay platforms to maximize availability and distance between communication stations. For space applications, provided are space-fed lens satellite radio frequency antennas to generate many user beams while employing a novel frequency conversion scheme for compact accommodation on small satellites, overlapping ground coverage from multiple satellites, high-altitude platforms relaying signals between satellites and gateways as needed, and compatibility with conventional radio frequency user terminals.

### CROSS-REFERENCE TO RELATED APPLICATIONS

This application claims priority from a U.S. Provisional Patent Application Ser. No. 63/246,473, filed on Sep. 21, 2021, which is incorporated herein by reference in its entirety.

### FIELD OF INVENTION

The present invention relates to a broadband network and free-space optical links, and more particularly, the present invention relates to a system and method for higher capacity and coverage of broadband networks using free-space optical communications links.

### BACKGROUND

Advanced over-the-air communication systems generally use Ku, Ka, and V-band microwave or radio frequencies (RF) for high-throughput internet connectivity. Terrestrial systems, however, are limited to the use of RF frequency range that provides a lesser speed of a few megabits per second. Presently, high-capacity satellite broadband systems typically require thousands of low-earth orbital (LEO) satellites and a large number of gateways. This requires a huge upfront cost, which few business entities can afford. Moreover, for increasing the capacity, the cost increases exponentially, which limits the present infrastructures to a few terabits per second. Besides the cost, the limited availability of RF spectrum is posing a different set of challenges.

Replacing RF-based gateways with optical link gateways appears to be an attractive option. However, the telecommunications industry has been hesitant to adopt optical gateways due to the huge costs of high-throughput optical terminals and the spatial diversity required to provide sufficient availability under various atmospheric conditions.

Several solutions have been proposed in the prior art, however, they fail to address one or more limitations or drawbacks. For example, U.S. Pat. No. 10,707,961B2, “Adaptive Communication System” discloses an optical communications satellite constellation that uses high-altitude pseudo satellites to make the link between the satellites and the gateways, wherein high-altitude pseudo satellites convert RF forward data streams from the gateways to optical frequencies for transmission to the satellites and convert the return optical data streams from the satellites to RF for transmission to the gateways. While this allows conventional gateways to be used, the use of RF for the “last mile” for the gateway-satellite link limits system capacity to that of an all-RF system, defeating the high-capacity benefit of the optical architecture. U.S. Pat. Nos. 9,917,646 B2, 10,320,481 B2, 10,069,565 B2, and 10,142,021 B2 envision several variants of optical satellite constellations with optical gateways. However, they all use conventional optical modulation techniques which fundamentally limit the capacity of the system and they each have additional shortcomings. U.S. Pat. No. 9,917,646 addresses a forward link design in which the user signal at its RF downlink frequency is wave-division-multiplexed onto the optical link to avoid onboard digital processing. This patent does not address how to effectively generate a high data rate RF or optical system capacity nor the method of modulation that enables a high-capacity optical system design.

U.S. Pat. No. 10,320,481 describes a method for allocating bandwidth and addressing data streams to users, then combining these signal streams via wave-division-multiplexing and up-converting them onto optical frequencies. This conventional modulation approach limits system capacity adversely. U.S. Pat. No. 10,069,565 discloses a variant of this system using on-board processing (OBP) of all signals on the satellites; while this is presented as a potential way for minimizing the number of gateways, OBP adds significant mass, power, and complexity to each satellite which dramatically increases system cost without any direct capacity benefit. Lastly, patent 10,142,021 provides a similar system, but in recognizing the prohibitive cost of digital OBP, it places the routing function in the gateway in a form of Ground-Based Beamforming (GBBF) thus predesignating the routing information into the signal stream.

The publication “Feasibility of An Optical Frequency Modulation System for Free-Space Optical Communications” by Luryi and Gouzman, International Journal of High-Speed Electronics and Systems, Vol. 16, No 2 (2006), pg. 559-566, considered an optical version of a well-known wideband frequency modulation technique that inherently has a high signal-to-noise ratio. This optical wideband frequency modulation (OWBFM) concept has not been implemented and requires the development of a rapidly tunable laser diode at the frequency appropriate to a specific application.

Thus, considering the immediate need for high-capacity broadband networks at low costs, a need is appreciated for a system and method that overcomes the aforesaid drawbacks and limitations with traditional RF-based and optical-based gateways.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for higher capacity broadband networks at a lower cost.

It is another object of the present invention that both and capacity and latency of the network can be improved.

It is still another object of the present invention that the number of satellites needed can be reduced.

It is a further object of the present invention that the number of gateways needed can be reduced.

It is still a further object of the present invention that the dependence on the radio frequency spectrum can be reduced.

In one aspect, disclosed are a system, an architecture, and method for the provision of terrestrial point-to-point, high-altitude platform, and satellite broadband data services by using a free-space optical communications link in conjunction with an extremely-high-data-rate (EHDR) wideband frequency modulation waveform. The invention supports high data capacities, greater than an order of magnitude over current point-to-point optical communication systems for both earth and outer space applications as well as over the most capable Low Earth Orbit (LEO) satellite constellation being envisioned and deployed in the 2020-2025 timeframe. To achieve these exceptional capacities at a conventional cost, the disclosed system, architecture, and method use wideband frequency modulated (WBFM) optical links that permit the use of compact optical terminals. For terrestrial applications, the system, architecture, and method additionally can implement high altitude relay platforms (HARPs) for better availability and longer distance coverage. For space applications, the system, architecture, and method use space-fed lens satellite Radio Frequency (RF) antennas that generate multiple beams, a novel frequency conversion scheme for compact accommodation on small satellites, overlapping ground coverage from multiple satellites, and high-altitude relay platforms (HARPs) to relay signals between satellites and the gateways. The disclosed system allows standard, available satellite user terminals to be used since conventional Ku-band and Ka-band RF links are used for user communications links. The disclosed system and method also enable high-capacity terrestrial, planetary, and outer space communications systems.

In one aspect, the disclosed system, method, and architecture allow for an unconventional combination of technical and architectural features that synergistically enables high system data capacities in satellite constellations, far greater than that of prior art system concepts. These enabling features include (1) incorporating high data rate modulation technique i.e., wide-band frequency modulation (OWBFM), to aggregate constellation data streams into those satellites in view of and communicating with the gateways, (2) using an all-optical satellite-to-gateway and satellite-to-satellite architecture, (3) limiting the gateways to a minimal number, located in areas with historically proven clearest sky conditions, (4) capitalizing on WBFM's inherently high signal-to-noise ratio so that high capacity data can be optically transmitted at modest power levels and thus with low-power, cost-effective satellites, (5) modulating user RF data directly onto the optical carriers without digital on-board processing and routing on the satellites, thus avoiding significant satellite mass, power and cost penalties, and (6) incorporating a novel RF beamforming technique that enables forming a large number of beams per satellite using antennas of modest size and therefore enabling smaller, cost-effective satellites to be used. Each of the above features alone does not increase the capacity significantly, but the disclosed implementation provides a significant increase in the total data rate throughput of a satellite system. In addition, elements of the architecture may be used to significantly increase data rate capacity in certain terrestrial applications where free-space optical communications are desirable for geographical, infrastructure, and/or security reasons, as well as in lunar, planetary, and outer space applications.

In one aspect, the disclosed system and method can attain high-capacity satellite system communications where broadband services are needed continuously across the moon's surface, across planetary surfaces, from and to Lagrange points, and between other outer space communication points. For this type of application, the satellite system communicates directly to user terminals and gateway terminals in orbit and/or on the lunar or planet surface.

In one aspect, the disclosed system and method can attain high capacity over-the-air point-to-point terrestrial communication service including ship-to-ship communications. OWBFM can be used to efficiently increase the data rate for a given application's terminal size and power. The capacity and coverage can be further enhanced by using HARPs to achieve greater communications and point-to-point distances from and to a given terminal. If used, the HARPs can utilize a “bent pipe” analog architecture versus a digital architecture to avoid digital processing's higher complexity, mass, and power.

In one aspect, disclosed is a high-capacity communication system incorporating several features applied to increase data service capacity cost-effectively and dramatically for both microwave satellite links to user terminals and free-space point-to-point communication solutions. Both solutions are served through a number of common synergistic features: A high-capacity optical waveform wherein multiple RF baseband carriers, after adaptive coding digital modulation (ACM), are wide-band frequency modulated into optical data streams which then are Wavelength Division Multiplexed (WDM) onto optical beams for transmission; and A “bent pipe” analog communications architecture to avoid the complexity, mass, power, and cost of analog-to-digital and digital-to-analog conversion;

Terrestrial, lunar, planetary and outer space applications are further achieved through the following synergistic features: the use of terrestrial optical terminals (TOTs) providing point-to-point service to access the Internet backbone, users, and/or RF microwave towers for local RF distribution to users; and sufficient spatially isolated optical terminals at each communication point to maintain links with other communication points, HARPs, drones, or satellites in view via multiple optical beams. In terrestrial applications, TOTs are optionally supported with HARPs or drones to extend the transmission range or to provide communication path redundancy. Such TOT architectures can also be adapted for use on surfaces of other celestial bodies such as the Moon and Mars as well as free-flying space vehicles.

In one aspect, a high-capacity satellite system is achieved through the following synergistic features: A high-altitude Low Earth Orbit (LEO) satellite constellation, such as a Walker-Delta configuration, that provides full-earth coverage by both ascending and descending satellites; Optical gateways (OGWs) placed in locations with historically minimal cloud coverage in the northern and southern hemispheres and connected by high-capacity fiber to global Internet data trunk networks; Optical communication links between gateways and satellites, including via relay systems used to mitigate link disturbance due to atmospheric phenomena and to support capacity maximization; Sufficient spatially isolated optical terminal clusters, and terminals within those clusters, within each OGW installation to communicate with all satellites in view via multiple optical beams per satellite; Optical inter-satellite links to enable data routing, via other satellites, from (to) satellites out of view of an open OGW to (from) satellites in view of an open OGW; Switching RF user communication bands and/or polarizations when satellites reach their maximum latitudes in the polar regions to provide simultaneous full earth coverage by user beams, provided by ascending satellites in one RF band/polarization and by descending satellites in another RF band/polarization, while avoiding crossing plane interference; Providing a large number of RF user beams in both bands and/or polarizations by the use of space-fed lens multibeam phased array antennas onboard each satellite; Conducting the beamforming in the space-fed lens antennas at a high RF millimeter wave frequency to reduce antenna volume and thereby enable efficient accommodation of as many as four such antennas on each of the small satellites; Corporate (i.e., as one body) scanning of all RF beams produced by the space fed lens antennas in order to compensate for the orbital motion of each satellite and provide beam dwell times of minutes, after which a fast constellation-wide raster scan hands each ground coverage area over to the next following satellite; An RF user beam coverage footprint that overlaps with those of several adjacent (in and out of plane) spacecraft, providing multiple spatially-isolated overlapping beams, thus multiplying bandwidth available to users; A capability to begin global operations with a one-quarter subset of a full constellation which provides continuous, but not yet overlapping Earth coverage by both ascending and descending satellites; To increase capacity, accessibility, and effective availability of the OGWs and limit their number and cost, using the use of high-altitude relay platforms (HARPS) flying over OGWs to relay optical signals from and to satellites that are or may be subject to signal interference by clouds or turbulence and those that are at low elevation and thus at greater risk of atmospheric interference if using direct OGW links; Compatibility with most terrestrial customer premise equipment (CPE) for current and planned commercial, military, and space exploration systems, supporting an easy transition for satellite internet users to this new system. The foregoing enumerated features enable a method and system employing optical links using an extremely-high-data-rate (EHDR) waveform in combination with miniaturized space-fed lens satellite RF antennas that generate many user beams while using a novel frequency conversion scheme to fit on small satellites, as well as overlapping ground coverage from multiple satellites at multiple radio frequency ranges or polarizations, leading to unprecedented bandwidth available to satellite users.

The aggregate user data rates for the disclosed system exceed those of current single-band (Ku or Ka-band) systems by at least a factor of up to 30, comprising of factor 2 for the ability to use two RF bands, a factor 4 for the overlapping coverage, and another factor 4 to 5 due to the many user beams per satellite-enabled in part by the compact antenna form factor. Individual users can select a data rate service level appropriate to their needs by choosing how many satellites they wish to access, in one or both RF bands and/or polarizations, from the overlapping coverages.

### BRIEF DESCRIPTION OF THE DRAWINGS

A clear understanding of the key features of the invention summarized above may be had by reference to the appended drawings, which illustrate the method and system of the invention by using an example case, although it will be understood that such drawings depict exemplary embodiments of the invention and, therefore, are not to be considered as limiting the scope of this invention which clearly contemplates the tailoring of embodiments to specific implementation objectives, constraints, and parameters. Accordingly:

FIG. 1 shows a Low Earth Orbit satellite constellation orbital configuration known in the art.

FIG. 2 shows low-cloud-coverage locations for siting the OGW installations around the world, according to an exemplary embodiment of the present invention.

FIG. 3 illustrates the satellites visible to an OGW within and outside the acceptable elevation angle at a notional point in time, according to an exemplary embodiment of the present invention.

FIG. 4 illustrates a notional satellite configuration, according to an exemplary embodiment of the present invention.

FIG. 5 illustrates optical WBFM communication signal paths, including redundancy paths, among OGW optical terminal clusters, satellites, and HARPs, according to an exemplary embodiment of the present invention.

FIG. 6 illustrates the use of WBFM to distribute internet to users via TOT relays and how local availability can be further enhanced using HARPs, ground-based microwave transmission, and RF transmission to satellite redundancy paths, according to an exemplary embodiment of the present invention.

FIG. 7 illustrates a satellite terminal-to-terminal optical WBFM payload block diagram, according to an exemplary embodiment of the present invention.

FIG. 8 illustrates the channelization used for the free-space optical communication forward-link waveform, according to an exemplary embodiment of the present invention.

FIG. 9 illustrates optical wide-band frequency modulation (OWBFM) and multiplexing of the optical carriers used by the free-space optical communication forward-link waveform, according to an exemplary embodiment of the present invention.

FIG. 10 illustrates a forward link block diagram showing the translation of an OWBFM communication signal received by a satellite from an OGW ground terminal or another satellite to RF frequency beams that can be transmitted to user earth stations, according to an exemplary embodiment of the present invention.

FIG. 11 illustrates the optically uplinked spectrum conversion to the millimeter waveband band and demultiplexing to four-color forward link Beamformer Network (BFN) channels, according to an exemplary embodiment of the present invention.

FIG. 12 illustrates baseband carriers for the return link after being multiplexed into baseband signals once received by the spacecraft RF phased array, according to an exemplary embodiment of the present invention.

FIG. 13 illustrates a block diagram of the translation of RF frequencies received from user earth stations by satellite to an OWBFM communication signal that can then be transmitted to another satellite or an OGW ground terminal, according to an exemplary embodiment of the present invention.

FIG. 14 illustrates the microwave beam coverage area for one satellite as well as six neighboring satellites in the initial 400-satellite constellation, according to an exemplary embodiment of the present invention.

FIG. 15 illustrates the microwave beam coverage area for the satellites of FIG. 14 as well as the additional satellites covering this region in the complete 1600-satellite constellation, showing the overlapping coverage of four satellites at any ground location, according to an exemplary embodiment of the present invention.

FIG. 16 illustrates a space-fed lens beamformer network (BFN) showing the forward direction operation, according to an exemplary embodiment of the present invention.

FIG. 17 illustrates the circular pattern of the transmitting and receiving surface elements of the Ku-band or Ka-band phased array antenna, according to an exemplary embodiment of the present invention.

FIG. 18 illustrates a space-fed lens beamformer network (BFN) showing the return direction operation, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

The following detailed descriptions represent exemplary embodiments of the invention. Parameters may be modified to meet specific objectives of the implementation without departing from the essential scope of this invention.

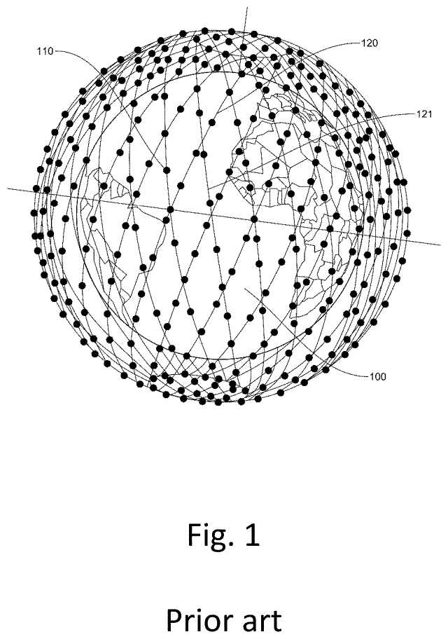

An example satellite constellation, shown in FIG. 1, is a high-altitude Walker-Delta constellation consisting of 1,600 satellites 110 orbiting in 40 equally distributed planes of 40 satellites each, in a circular orbit at approximately 1,680 km altitude at approximately 76.86-degree inclination. This configuration provides an orbital period about the earth 100 of approximately 2 hours and a node progression rate of approximately 1 degree per day. This example approach has advantages in being able to provide full coverage with only 400 satellites.

Ascending parts 120 and descending parts 121 of the orbits are both used for user communications but employ different RF bands or polarizations to avoid crossing plane interference. Satellites traversing the sparsely populated high latitudes, where user traffic is light or absent, are in a position to switch RF bands or polarizations. Users can see one ascending and one descending satellite with the initial 400 satellite constellation, and four ascending and four descending satellites with the full 1600 satellite constellation.

In addition, the main function of a satellite changes through each orbit as a function of the character of the part of the Earth in the satellite's ground coverage. Satellites over highly populated areas i.e., with a high density of users, will primarily provide user service and feed their optical signals to other satellites. On the other hand, satellites over oceans and sparsely populated areas will primarily perform an optical network relay function. Satellites within view of an OGW will predominantly function to connect aggregated satellite network traffic to the ground.

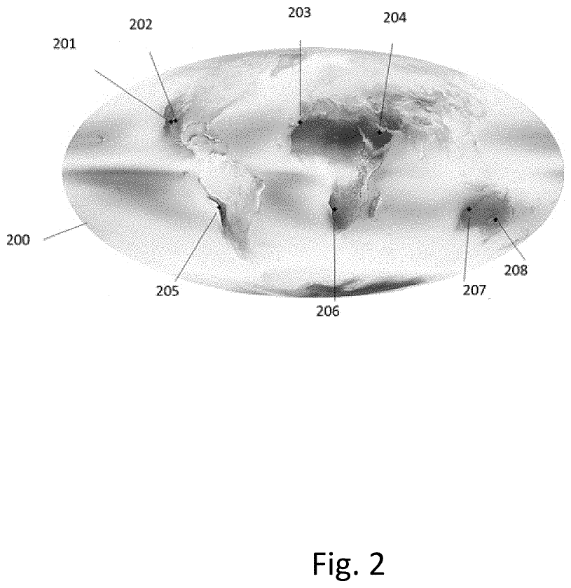

Considering factors such as latency, accessibility, ease of fiber trunk routing, security, and atmospheric turbulence, the example constellation prioritizes low-cloud, high availability, locations for OGW sites. FIG. 2 illustrates these favorable regions on a nearly 14-year average NASA cloud cover map 200 based on measurements from NASA's Moderate Resolution Imaging Spectroradiometer (MODIS) instruments on its Aqua and Terra satellites. They are in specific areas in the southwestern United States 201, 202, Morocco 203, Saudi Arabia 204, Chile 205, Namibia 206, Western Australia 207, and Eastern Australia 208.

In addition, more specific siting within these and/or similar regions will be influenced by the degree of prevalence of clear-sky atmospheric turbulence which can interfere with the direction and noise characteristics of optical beams. Such turbulence is in part influenced by prevailing wind patterns and ground features and considering it in OGW siting can help minimize its potential impacts on optical communications performance. Furthermore, the specific siting of an OGW in these or other areas will be influenced by accessibility, terrain, security, availability of resources, and ease of fiber trunk routing to a major internet node.

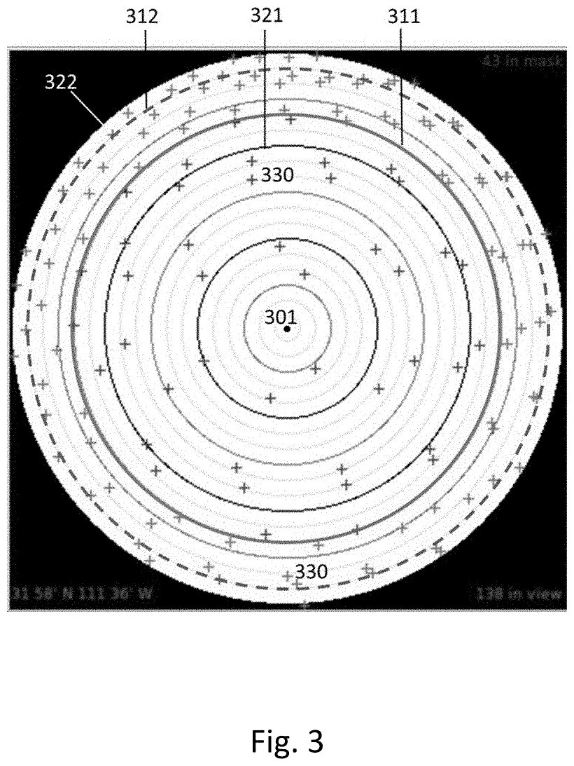

FIG. 3 illustrates the location of earth-orbiting satellites orbiting overhead as viewed from an OGW terrestrial installation. In this fisheye view from the ground, the OGW 301 is at the center of the diagram. Circle 311 encloses the acceptable elevations for satellite optical communications; in this example, these are all elevations greater than 20 degrees with a zenith defined as 90 degrees. In many regions the minimum elevation angle may be at least 30 degrees, indicated by circle 321, to ensure high probabilities of establishing suitable optical links. Outside circle 311 lies a zone from which the elevation angle would typically be too low to establish a direct satellite-to-OGW optical communications path with high reliability and availability. The zone between circle 311 and circle 312 encloses the elevation angles that are serviced by the HARPs which, due to their high altitude, support direct optical communication with satellites that are above approximately 5 degrees and higher elevation as indicated by circle 322. The HARPs relay the optical signals to and from the OGW. Symbols 330 indicate the overhead positions of satellites in view in these zones.

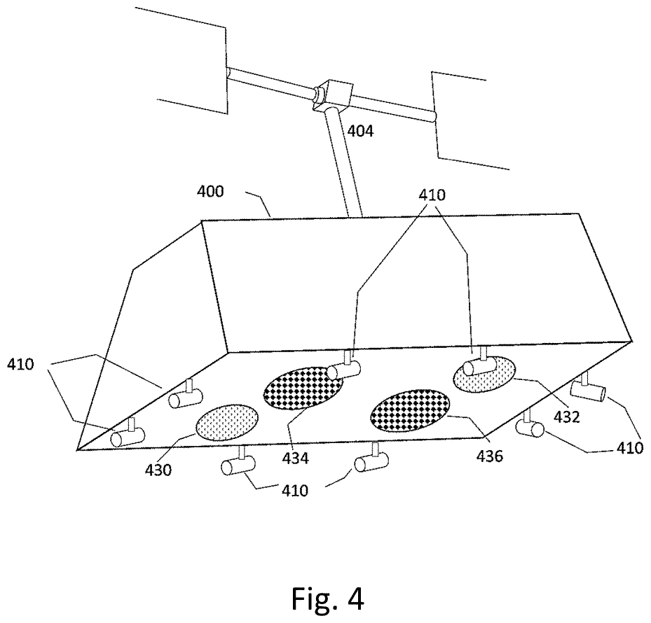

FIG. 4 illustrates a notional satellite configuration for the system of this invention. The main features are the satellite body 400, shaped in this example to provide an Earth-facing surface of sufficient size to accommodate the communications antennae and the optical terminals. In this configuration, the user transmitting (forward) antenna 434 and receiving (return) antenna 436 for one RF band, the user transmitting (forward) antenna 432 and receiving (return) antenna 430 for a second RF band (if used) are located on the Earth-facing deck. The eight (or more) optical heads or terminals 410 for communication with other satellites, HARPs and OGWs are also located on or in the proximity of the Earth-facing deck. The satellite may include additional optical heads to maintain backup OGW links to enable near-instantaneous switchover in case the primary links are interrupted by atmospheric conditions, or to maintain active redundant OGW links during a pass deemed at risk of signal degradation. The satellite optical terminals 410, while represented as simple cylinders, are precisely aligned assemblies of multiple receiving telescopes and laser transmitters serving the coarse acquisition, fine tracking, and laser communication functions, steerable in two axes and well protected from variable thermal conditions in space.

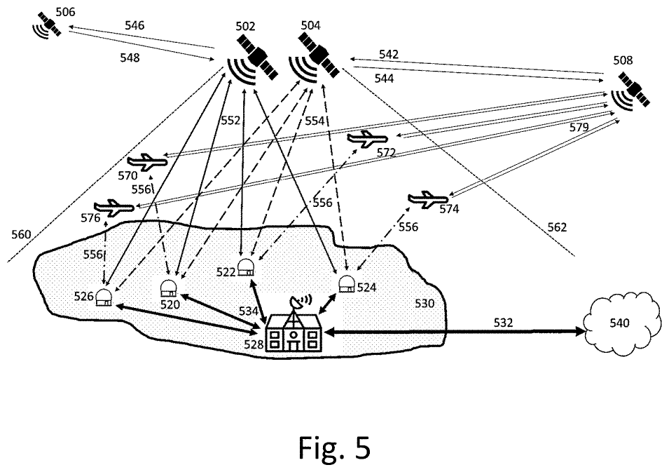

FIG. 5 illustrates the system elements involved in linking the optical satellite signals to the ground infrastructure and the internet. This includes satellites 502 and 504 which are over the OGW region, satellite 506 which is remote from the OGW region, and satellite 508 in view of, but with a low elevation angle to the OGW. These are illustrative satellites only; in the full system, many more satellites will be in similar positions relative to the OGW. The OGW operations region 530 includes the OGW processing facility 528, the OGW communication nodes, called optical terminal clusters (OTCs) 520, 522, 524, and 526, and the fiber backbone 532 connecting the OGW to the internet cloud 540.

The OTCs include multiple optical transmit and receive terminals that each communicate with a satellite within the appropriate elevation angle 560 and 562 of the OGW region. The number of operating OTCs will be at least equal to the number of optical spatially isolated beams transmitted and received from a single spacecraft, which is four in the example of FIG. 5. Redundant OTCs can be used to address OGW constellation communications availability. The distribution of the OTCs over the OGW operations area 530 is sufficiently wide to support spatial isolation of the beams which enables optical frequency reuse to achieve the exceptionally high capacity of the disclosed system. In addition, wider separation of OTCs within the OGW area provides a higher probability of identifying alternative satellite-OTC link routings in case the most direct routing is impacted by severe atmospheric turbulence.

To facilitate the optical signal acquisition, all-optical terminals will transmit wide beacon beams parallel to the narrow fine-tracking beacon and receive and transmit communication beams. Similarly, they are equipped to receive the acquisition and fine-tracking beacons emitted by the satellite laser terminals. The OTCs are connected to the OGW processing facility 528 by optical fiber links 534.

Transmit and receive beams (552 and 554) are shown going to and from multiple satellites, for example, 502 and 504, from and to the OTCs. Each satellite has multiple optical terminals to either transmit to the OGW or adjacent satellites via crosslink transmit and receive beams, for example, beams 542 and 544 between satellites 504 and 508 and beams 546 and 548 between satellites 502 and 506. This enables satellites 506 and 508 to communicate with the OGW via satellites 502 and 504, respectively.

To provide maximum capacity and optical path diversity, high-altitude relay platforms (HARPs) 570, 572, 574, and 576 are used to communicate between OTCs 520, 522, 524, and 526, and a satellite 508 which is below the minimum elevation angle acceptable to the OTCs. In this example, optical crosslinks 579 are used to relay the communication between satellite 508 and the HARPs and from there via beams 556 to the OTCs. This significantly increases data transmission to and from the OGW by giving the OGW access to satellites that are at very low elevation angles but that can readily establish a link to the HARPs as those are operating above 90% of the earth's atmosphere. HARPs are also used by satellites that have acceptable elevation but cannot access the OGW directly due to clouds or severe atmospheric disturbances. In OGW regions and/or conditions where atmospheric turbulence is common and/or severe, HARPs can be used as routine intermediary relays for all communications between satellites and the OGW. Each HARP is functionally an upper-atmosphere extension of a specific OTC.

OTC aperture size may also be varied to optimize each OGW site's availability. This is an element of the investment and operational cost tradeoffs between satellite optical terminal power, satellite and OTC optical telescope sizes, and the extent of the use of high-altitude relay platforms as an intermediate relay to reduce the risk of optical link disruption due to atmospheric effects. Overall assessment, design, and optimization of the optical links will take into account the various loss factors such as atmospheric absorption, optics imperfections, beam wander due to turbulence, scintillation and jitter, and wavefront phase error.

An OGW operations region 530 need not be a single contiguous land area but can be a distributed installation joined together by optical fiber links. OTCs will be distributed so they are separated by a sufficient distance to ensure sufficient spatial isolation for optical beams between the OTCs and any satellite while accounting for the steering precision and resolution of the satellite optical heads. In addition, each optical terminal cluster itself is further distributed (not detailed in FIG. 5) within a limited ground footprint to support, with adequate spatial isolation, the many optical beams from the HARPs which will be relaying optical beams from many satellites simultaneously.

The phenomenon of atmospheric turbulence is mitigated via a combination of predictive and real-time measures. Predictive selection of a satellite-OTC link path for each satellite pass is based on the characterization of historical turbulence patterns correlated with seasonal-, diurnal-, and weather-driven upper-atmosphere conditions, and refined based on link performance from just-completed passes by other satellites. When significant turbulence is likely, signals can be relayed via HARPs to the OTCs or via other satellites to another OGW. Real-time measures include a fast-steering mirror (FSM) within the optical terminal assemblies to steer out any moderate-frequency beam wander due to turbulence and other atmospheric effects.

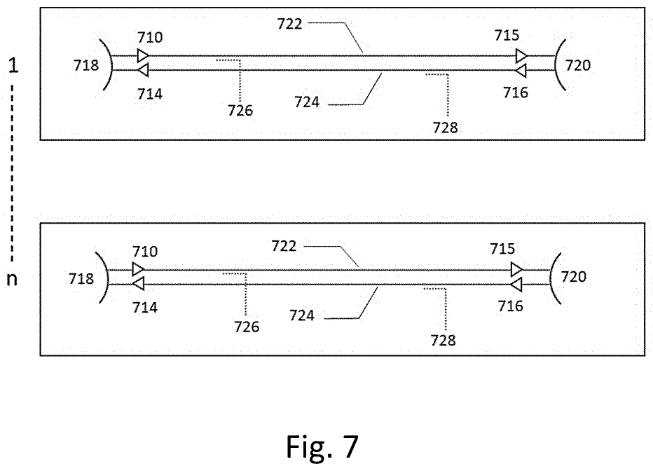

The satellite optical repeater design between optical terminals 718 and 720 is shown in FIG. 7 for both forward 722 and return links 724. This OWBFM-based design applies to both satellite optical crosslinks and satellite terminals communicating with OGWs. In the forward direction 722, the optical signal is received by an optical terminal 718 from an OGW or a satellite cross-link. The light wave signal passes through a fiber optic cable, through a low noise amplifier 710. Then the beam passes through a power amplifier 715 where the beam goes into a satellite optical terminal 720 where it is transmitted from the satellite to another satellite's optical terminal or an OGW. A portion of the forward link signal may be coupled off by a coupler 726 to be processed for transmission by an RF antenna from the satellite to RF user terminals. In the return direction, RF channels from RF user terminals are received by the satellite through an RF antenna. The frequency is converted and multiplexed into multiple multi-channel baseband signals, each used to modulate wide FM optical carriers that will be wavelength-division multiplexed into the return link optical path from an optical terminal 720 to another optical terminal 718 via an optical coupler 728. The return link optical beams will be relayed in such a fashion from satellite to satellite in accordance with a routing table supplied to the satellite by a previously accessed OGW until they reach a satellite in view of an OGW.

An optical transmit beam consists of multiple frequency/wavelength division multiplexed laser beams illuminating the optics of a telescope from a single optical feed (fiber) at the focal point of the telescope. Each wavelength in the laser beam will be wide-band frequency modulated (WBFM) by baseband (low intermediate frequencies) consisting of multiple Frequency Division Multiplexed (FDM) channels containing DVB S2 or similar Adaptive Coding and Modulation (ACM) modulated carriers for the forward links.

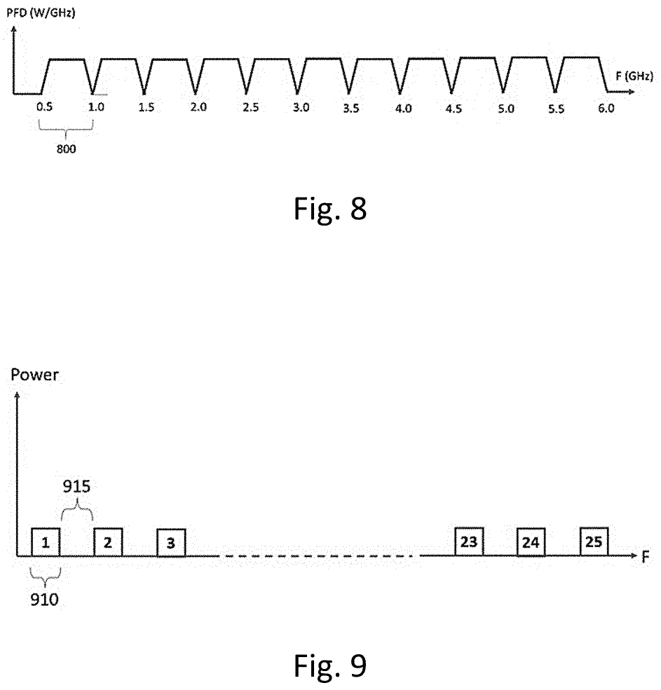

In the case of satellite microwave transmission, the forward channel carrier is destined to be transmitted on a downlink beam to a user terminal on the Earth. Each ACM downlink carrier is time-division multiplexed to the individual user with modulation and coding (data rate) appropriate to the user's currently reported link condition (signal-to-noise ratio). FIG. 8 shows an example multiple forward-link baseband spectrum.

As shown in FIG. 8, a group of baseband channels (800) is FM modulated into a single optical carrier; the total bandwidth, for example, of an 11-channel, baseband spectrum used for one optical carrier is 5.5 GHz for a baseband channel size of 500 MHz. A 500 MHz bandwidth microwave beam under clear sky conditions can support a data rate of 2.5 Gbps based on a clear sky spectral efficiency of 5 bps/Hz.

FIG. 9 shows an example of the optical beam spectrum after WBFM modulation and multiplexing of the optical carriers 901. In this example, there are a total of 25 optical carriers. Given eleven microwave channels per optical carrier and 25 optical carriers, this example provides a total of 275 microwave channels (11×25) represented in one optical beam. With 5.5 GHz of bandwidth per optical carrier, this represents 137.5 GHz per optical beam (25×5.5 GHz) in this example. The bandwidth 910 of the optical carrier based upon a modulation index of 4, is approximately 16.5 GHz. The modulated optical carrier bandwidth is twice the sum of the carrier bandwidth (16.5 GHz) and the highest modulation signal frequency (6.0 GHz) or 45 GHz. The guard bandwidth 912 in this example would be approximately 160 GHz, or roughly 10 times the carrier peak deviation, which yields a very high FM signal-to-noise ratio (SNR). The high SNR significantly reduces the optical power required in the optical feeder link system, enabling very high-capacity data transport through small optical terminals.

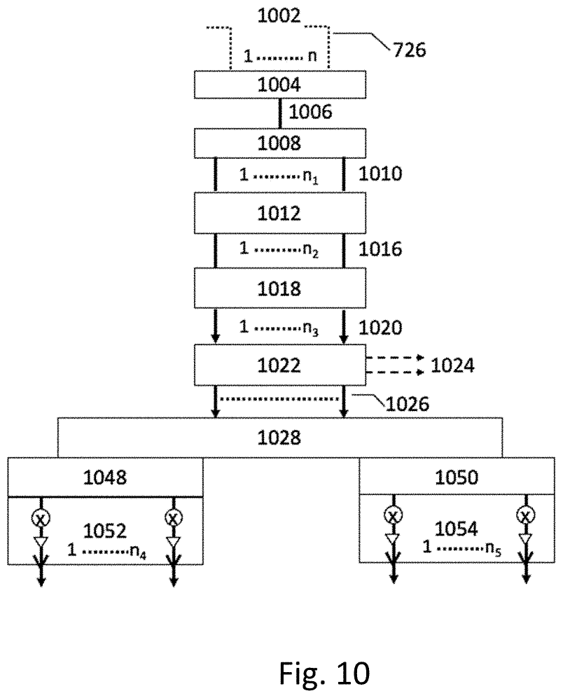

The satellite forward-link communication signal from the optical terminal fiber couplers (item 726 in FIG. 7) to the microwave antenna is described in FIG. 10.

Fiber couplers 726 are used to sample four (or n) fibers connecting four (or n) inputs to four output optical terminals for the OGW links. An n:1 fiber optic switch 1004 selects one of four (or n) paths (or fibers) 1002 to convert the signal into a single optical beam (fiber) with, for example, 12 of 25 (for 132 or 12 times 11 channels of downlink microwave beams) carriers/wavelengths 1006.

Optical carriers (λ) are then demultiplexed 1008 from the fiber 1006 into a set of optical carriers 1010. Each carrier (1 of n1) is sent through a frequency converter 1015 using tunable lasers feeding optical mixers to select embedded channels, along with heterodyne detection to convert the optical channels into millimeter wave WBFM carriers or channels 1016 in the millimeter frequency range. The WBFM signals are then demodulated 1018 into multichannel microwave baseband channels within each (1 of n3) microwave carrier 1020. Baseband channels that contain configuration commands for the antennas are diverted 1024 to the spacecraft processor. After demodulation, the channels are power split 1022 into even-odd channels that are distributed 1028 to one or more satellite RF antennas consisting in this example of a beamformer (1048 and 1050) and an output stage (1052 and 1054) including down-conversion to the proper RF frequencies, amplification, and radiating elements for transmission to users on the ground.

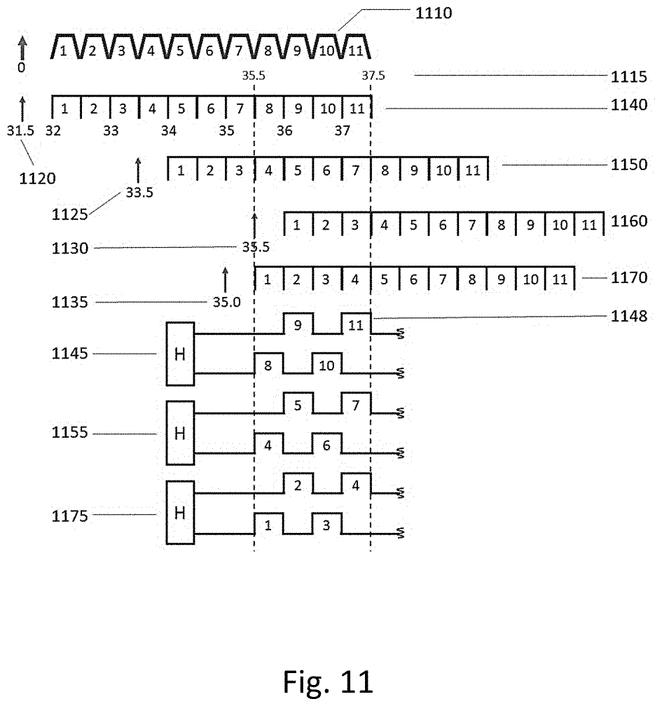

The baseband stream of channels 1110 is power divided into three copies, each of which is frequency shifted to millimeter bands as shown in FIG. 11 using local oscillator frequencies (1120) and (1125) and one of (1130) or (1135). This process converts the baseband to three groups of four adjacent channels or “colors” to a range of frequencies from 35.5 GHz to 37.5 GHz (1115) in this example. A four-color beam architecture refers to the use of four different frequency ranges to create a hexagonal beam pattern on the ground where no beam is adjacent to another beam of the same frequency in order to avoid beam-to-beam interference. In this example, baseband channels, after frequency conversion by local oscillator frequency 1120, are shown by 1140 to be 8, 9, 10, and 11. In a similar fashion, the local oscillator 1125 converts baseband channels 4, 5, 6, and 7 to the four-color region 1115, and the local oscillator 1135 converts four contiguous channels to the four-color beamformer band. Streams 1140, 1150, and 1170 are then sent to the three, four-channel, even-odd demultiplexers 1145, 1155, and 1175. The filters in the demultiplexers are labeled by the baseband channels (1-11) that have been translated to the four-color band 1115.

Each filter, for example, 1148 outputs the channel for which it is tuned to a transmission line, for example, 1149 and the none-selected channels continue to a termination. The 11 individual channel outputs of four colors are then sent to the beam inputs 1632 of the frequency-scaled forward downlink beamformer. This process is applied to all outputs from the wideband FM optical demodulators.

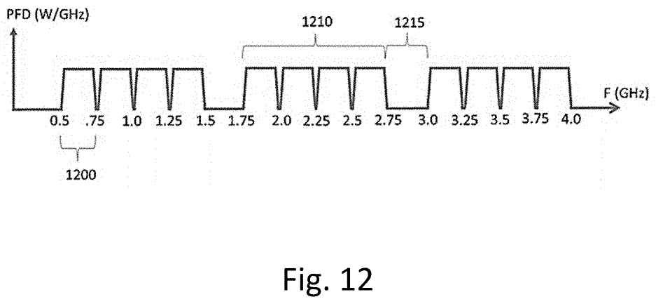

For the return path, FIG. 12 shows the baseband carriers after the signal is received by the spacecraft phased arrays and is multiplexed and converted to baseband. Item 1200 represents an example of a single bandwidth baseband channel. There are three groups 1210 of four channels 1200 that represent the baseband signals in the return. Item 1215 represents the guard band between the groups 1210 of channels.

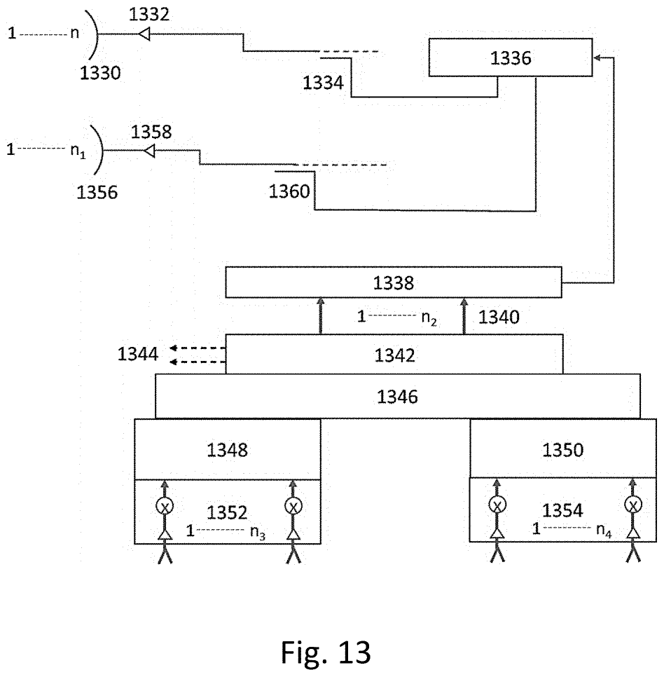

The satellite return-link communication signal path from the satellite RF antenna to the optical terminal fiber couplers (item 728 in FIG. 7) from the RF phased array is described in FIG. 13. The spacecraft RF antennas in this example are phased arrays in the Ka 1352 and Ku 1354 bands. The received uplink (return) signal beams proceed through low-noise amplification, frequency up-conversion, and channelized in beam forming networks 1348 and 1350 and then into a combiner/switch 1346. The purpose of 1346 and 1342 is to select the array beam outputs of either 1348 or 1350 and send time-division and frequency-division samples 1344 to a multi-channel spacecraft receiver used to monitor user terminal requests for service in uplink beams that are not currently connected to the OGW, and to convert the uplink channels to baseband for optical transport to the OGW via the feeder link network.

The baseband is composed of a number of sets of beam channels, with each set converted to a frequency range as illustrated in FIG. 12 example. Each of the sets of channels is modulated on a number of FM optical carriers which are then multiplexed using a wavelength division multiplexer (WDM) 1338 onto a single fiber. The multiplexed optical carriers are then sent to a switch 1336 either through an optical fiber coupler 1334 through a power amplifier 1332 to a satellite crosslink optical terminal 1330 or, if the satellite is in view of a ground system OGW, the optical carriers are transmitted through an optical fiber coupler 1360 through a power amplifier 1358 to a satellite optical terminal 1356 transmitting to the OGW, either directly or via a HARP.

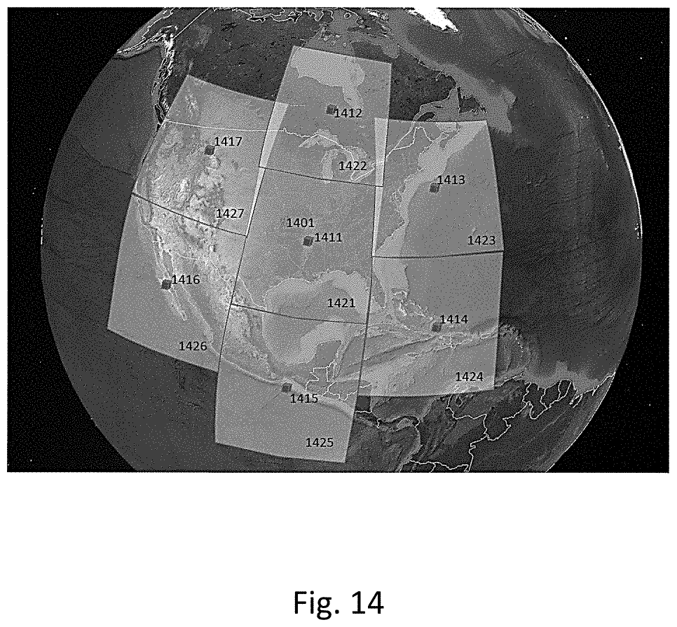

The user beam coverage is illustrated in FIG. 14 for the previously described example 400-satellite initial constellation. Ascending satellite 1411, in this example, provides a roughly rectangular coverage area 1421 of, in this example, 91 user beams. Leading and trailing satellites 1412 and 1415 in the same plane as satellite 1411 provide adjacent beam coverages in the roughly north and south directions. Satellites 1413, 1414, 1416, and 1417 in the adjacent planes provide beam coverages in the roughly east and west directions. These assigned coverages remain static as the satellites move through their orbits by scanning their beams via electronic steering with their phased array antennas. Thus, the satellites will only very briefly be over the center of their coverage area as in the snapshot in FIG. 14. Every six minutes, the beams perform a rapid forward raster scan across the entire constellation so that each satellite illuminates the next coverage area along its path.

User 1401 on the ground receives coverage, for example in the Ku band, from satellite 1411 for 6 minutes until the handoff to satellite 1415. However, user 1401 also has coverage from descending satellites, not shown, which are communicating, in this example, in the Ka-band. This provides a doubling of bandwidth available to user 1401 over conventional, non-optical systems which reserve the alternate RF band for OGW feeder link operations.

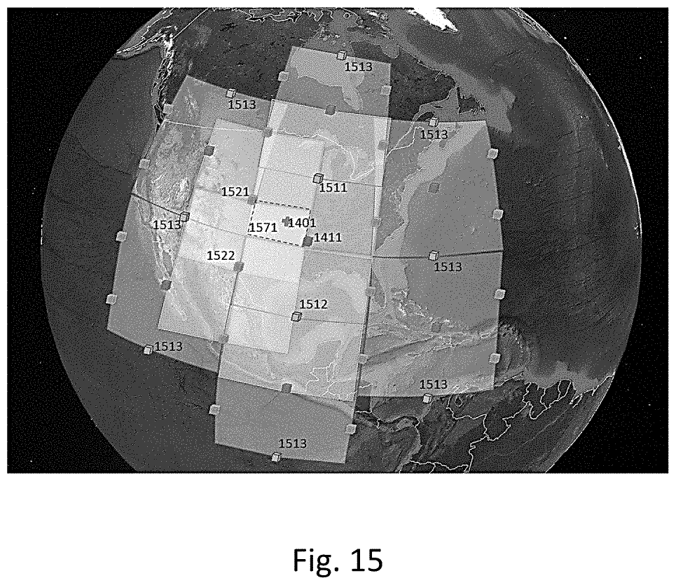

FIG. 15 illustrates beam coverage for the full example 1600-satellite constellation (FIG. 1). Ascending satellites 1511 through 1513 (the latter representing multiple satellites) have been added into the three planes of FIG. 14. Ascending satellites 1521 and 1522 are representative of satellites in intervening planes that have been added and populated and are highlighted for their relevance to the location of user 1401. User 1401 is now in the coverage areas of satellites 1411, 1511, 1521, and 1522, represented by coverage zone 1571. Including the descending satellites, not shown, user 1401 now has the benefit of eight times the available bandwidth compared to conventional, non-optical, lower-altitude systems. User 1401 can access the overlapping coverages 1571 of four ascending satellites in one band due to the beam angle spatial diversity of those four satellites, and similarly can access the overlapping coverages of four descending satellites in the other RF band.

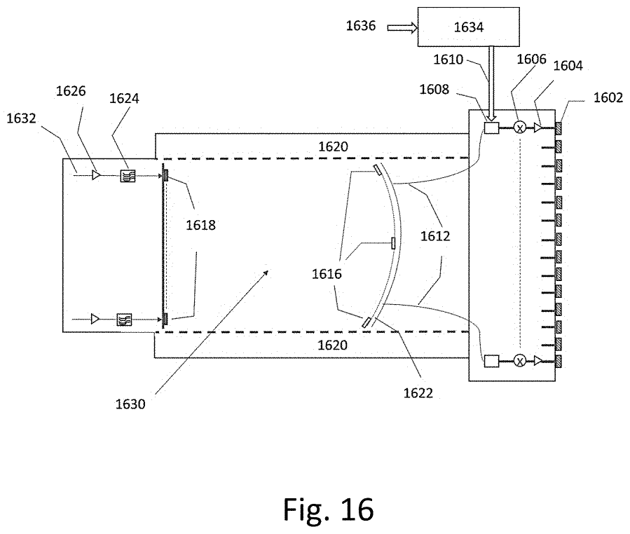

FIG. 16, with reference to FIGS. 7 and 10, describes how satellite transmit signals are processed and sent through a miniaturized space-fed lens beamformer network (BFN) and then frequency-translated to signals for radiation by a significantly larger Ku or Ka-band phased array antenna aperture. The space-fed lens is a particularly effective system solution because it permits corporate steering of all beams produced, enabling it to scan portions of the earth. i.e., the ground coverage area, with a large array of beams using a single receive or transmit surface. This is accomplished by putting a time-varying planar phase progression across the array elements by commanding the variable amplitude and phase circuits associated with each array element. This enables the array beams to track out orbital motion and maintain the dwell time of each beam on a specific location on the ground for durations of many minutes.

As illustrated in FIG. 7, the forward signals coming from the OGW enter the spacecraft optical terminal 718 designated by the OGW routing algorithm. The received optical beam signals are amplified by an optical low noise amplifier 710 and sent along with signals from other spacecraft via an optical fiber 722 to fiber optic power amplifier 715 and then to the optical terminal 720 for transmission to another satellite. A sample of the optical beam power is collected by optical coupler 726 and sent via fiber to an optical switch (1004 in FIG. 10) where it is selected from the “n” inputs and sent via fiber 1006 to an optical wavelength division demultiplexer 1008 where, for example, 12 of 25 optical carriers present at the input 1006 of the demultiplexer 1008, are sent via n1 (12 in this example) optical fibers to the optical wideband frequency demodulators 1012. The output of one of the frequency demodulators 1012 will consist of, in this example, 11 baseband channels per demodulator that will be demultiplexed and frequency converted to 4 groups of contiguous frequency channels at the space-fed lens BFN operating frequencies. The BFN operates at a higher frequency than the ultimate transmit frequency. This results in a very compact form factor for the BFN assembly, which facilitates fitting a space-fed lens on a small satellite. After beamforming, the individual beams are down-converted to the transmit frequencies.

These channels 1632 are then processed through a series of amplifiers 1626 and then go through a series of bandpass filters 1624 and then to a plane of elements at the input 1618 of the BFN 1630. Item 1620 represents the cylindrical anechoic absorber for the BFN where the dashed lines indicate the absorbing surface. Within the BFN 1630, the emissions from the radiating elements 1618 are absorbed by beam receive elements located at the end of the BFN 1616 chamber on the paraboloidal surface 1622. Key to the ability to scan the earth with the phased array as the satellite moves is the requirement that the electrical path lengths 1612 from each receive element 1616 to each associated transmit element 1602 through each variable amplitude and phase adjuster (VAP) element 1608 be the same. Command inputs 1610 are received by the VAPs from the spacecraft scan processor 1634 based upon constellation orbital data provided from the spacecraft telemetry system 1636. The scan processor 1634 determines how the signals are to be translated from the VAPs to the radiating elements 1602 arranged on the phased array element surface 1622 within the BFN 1630. The signals pass through a mixer 1606 where the millimeter band is received and then converted to the band required for the Ku- or Ka-band phased array. The channels then go through a series of power amplifiers 1604 before going to the feed elements 1602 of the K-band phased array transmit surface.

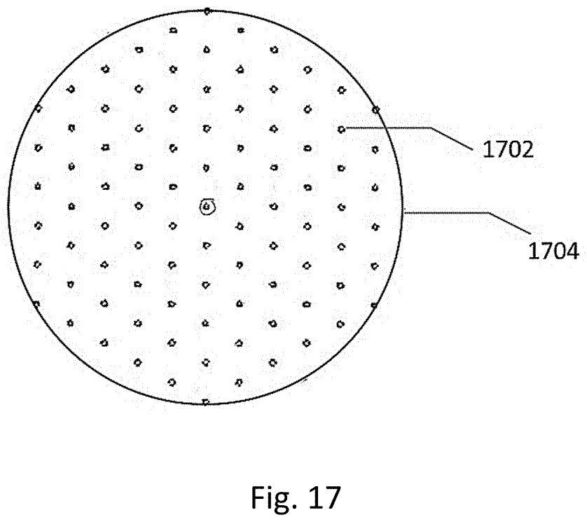

FIG. 17 represents 91 surface elements 1702 on the Ku-band or Ka-band phased array antenna surface (1502 in FIG. 15). The phased array elements are contained within a circular pattern 1704. The pattern of the beamformer elements (1616 in FIG. 16) is a scaled-down version of the radiating element pattern 1602 where the scale factor is the ratio of the RF frequency of the radiating array and the RF frequency of the beamformer.

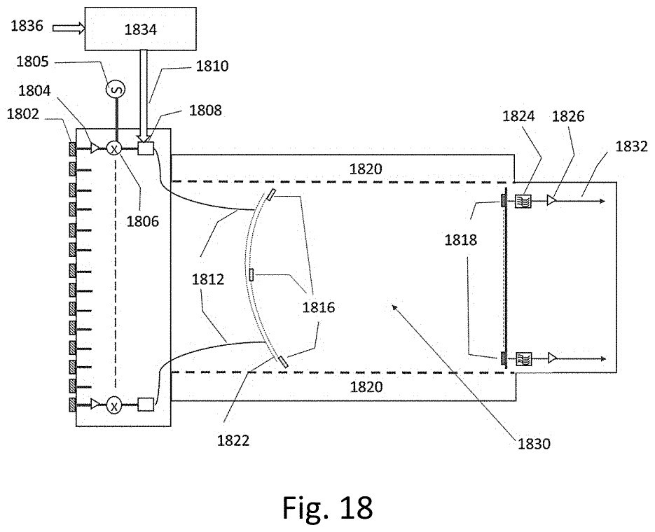

FIG. 18 describes the Ku- or Ka-band receive (phased) array, space-fed lens frequency-scaled beam former, and how the signal is processed through the receive elements through the BFN 1830 in a manner that allows multi-beam scanning. Item 1802 represents the feed elements on a K-band phased array receive surface. The signals pass through a series of low noise amplifiers or LNAs 1804, through a mixer 1806 driven by a local oscillator or LO 1805 where the K-band frequency is converted to a millimeter band. The signals are then passed through a group of variable amplitude and phase adjusters or VAPs 1808. Command inputs 1810 are received by the VAPs from the spacecraft scan processor 1834 based upon constellation orbital data provided from the spacecraft command system 1836. The scan processor 1834 determines how the signals are to be translated from the receive elements 1802 to the radiating elements 1816 arranged on the phased array element surface 1822 within the BFN 1830. Key to the ability to form beams and scan the earth with the phased array as the satellite moves is the requirement that the electrical paths 1812 from each of the receive elements 1802 to the corresponding transmit elements 1816 be exactly the same. Item 1820 represents the cylindrical anechoic absorber for the BFN where the dashed lines indicate the absorbing surface. Within the BFN 1830, the emissions from all the radiating elements 1816 are received by each beam receive element located at the end of the BFN 1830 chamber. The signals from each of these elements 1818 then pass through a bandpass filter 1824 of one of four specific frequency band segments (or “colors”) that are assigned to the users in that beam. The beam then passes through LNAs 1826 before multiplexing and modulation for OWBFM network routing of the resulting channels 1832 to the OGWs or to another spacecraft, as determined by the spacecraft processor.

Similar to the forward (transmit) BFN, the return (receive) BFN operates at a higher frequency than the received RF frequency. This results in a very compact form factor for the BFN assembly, which facilitates fitting a space-fed lens on a small satellite. Before beamforming, the individual beams are upconverted from the receive frequencies to the BFN operating frequencies. In addition, the use of the same BFN operation frequencies for both forward and return BFNs and in both Ku and Ka-band antennas enables significant hardware commonality between the four RF antennas on the spacecraft for cost-effective production and accommodation.

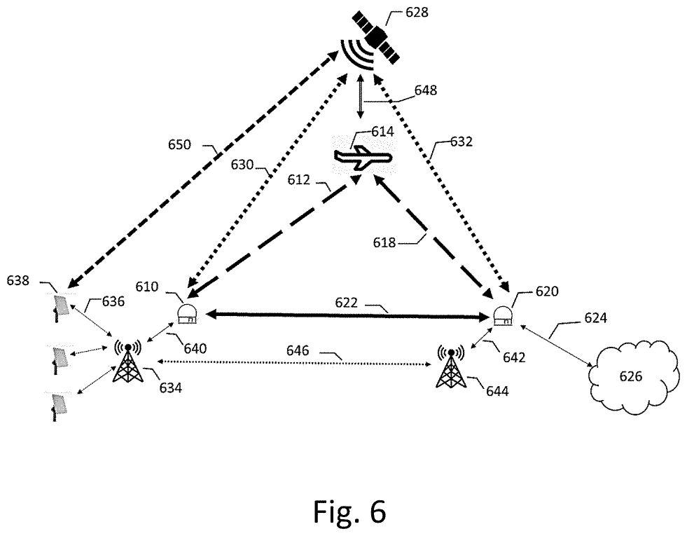

FIG. 6 describes how OWBFM can be used along with multiple system paths to distribute EHDR internet services leveraging terrestrial point-to-point transmission. Access to the internet cloud 626 is obtained through a Terrestrial-Optical-Terminal TOT 620 that is located close to the internet backbone and is therefore connected to the internet through fiber 624. The TOT communicates point-to-point via OWBFM and line-of-sight 622 to another TOT 610 that uses microwave or fiber 640 to access a nearby or co-located microwave tower 634. The microwave tower then communicates 636 via RF signals with broadband user terminals 638. While the optical communications distance is limited by atmospheric absorption, this approach can serve well where geological barriers obstruct the installation of traditional physical transmission infrastructure, or where privacy and security are at a premium. Additional TOTS serving as a network of relays can extend the range of optical communications. Additionally, to overcome atmospheric conditions, a HARP 614 can provide an overlay relay to receive and transmit 612 and 618 signals between two TOTs, and a satellite 628 can similarly provide an overlay relay to transmit and receive 630 and 632 signals between TOTs.

A third communications overlay approach is to use another microwave tower 644 co-located and connected 642 to the TOT 620 near the internet cloud 626 to receive and transmit to the other microwave tower 634 via RF 646. A fourth communication overlay approach is to use the HARPs system to relay between the remote TOTs and satellites 612 and 648 to enable cloud-free access to TOTs with direct internet access. A fifth communication overlay approach is to use a satellite 628 to access a TOT 620 through an optical communications link 632 and then use a satellite RF communications link 650 to communicate with the user terminal 638.

The above-described OWBFM communications architecture may also be advantageously applied to airborne drones serving as the source of high volumes of data to be transmitted or relayed to ground locations or as the destination for short-range redistribution of data to users on the ground. Similarly, the OWBFM architecture may be advantageously applied to ship-to-ship, ship-to-shore, and shore-to-ship communications. In each of these applications, the physical configuration of the architecture will be tailored to the specific performance requirements and operating environments of that application. This will involve, for example, the optical terminal sizing, quantity, power provisions, physical arrangement, axes and range of articulation, and provisions for operating them under the unique environmental conditions of each application.

Elements of the disclosed architecture can be applied advantageously to other space-to-space and space-to-ground communication needs. As lunar and planetary exploration proceeds, EHDR long-distance point-to-point communications on the surface of the Moon and Mars, for example, can be expeditiously established by locating a small number of optical WBFM stations on crater rims and other high-altitude sites, without the need for relay overlays due to the absence of an interfering atmosphere. In these applications, the physical configuration of the architecture will be tailored with regard to, for example, optical terminal sizing, quantity, power provisions, physical arrangement, axes and range of articulation, and provisions for operating them under the applicable environmental conditions.

Additionally, elements of the disclosed architecture can provide EHDR space-to-ground and ground-to-space communications can be supported by optical gateways, assisted by HARPs as appropriate, to communicate with deep-space spacecraft in transit to planetary destinations or orbiting the Moon, Mars, or other planets, or located on or orbiting any Lagrange point, with the implementation tailored to the specific requirements and environments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for providing a broadband network using free-space optical communication and satellites, the method comprising:
determining a plurality of optimum locations for a plurality of terrestrial gateways;
installing the plurality of terrestrial gateways at the plurality of optimum locations;
establishing optical wideband frequency modulated intersatellite relay links between member satellites of a respective constellation to relay data to one or more of the pluralities of terrestrial gateways, wherein the member satellites transmit and receive data via the optical wideband frequency modulated intersatellite relay links.

2. The method according to claim 1, wherein the method further comprises:
configuring the satellites in a Walker Delta pattern.

3. The method according to claim 1, wherein the method further comprises:
configuring the satellites to provide, in a fully populated constellation, partially overlapping radio frequency ground coverage with adjacent satellites in the same plane, and partially overlapping radio frequency ground coverage with satellites in adjacent planes.

4. The method according to claim 1, wherein the method further comprises:
configuring the satellites to provide user service ground coverage at different radio frequencies or polarizations depending on whether the satellites are ascending or descending relative to equator.

5. The method according to claim 1, wherein the method further comprises:
converting uplink radio frequency data streams using multiple adaptive coding digital modulation carriers into optical wideband frequency-modulated carrier links, without analog-to-digital and digital-to-analog conversion on satellites; and
converting downlink wideband frequency-modulated optical carrier links to multiple radio frequency baseband carriers and further frequency-translated for transmission to users, without analog-to-digital and digital-to-analog conversion on the satellites.

6. The method according to claim 1, wherein the method further comprises:
implementing a multibeam antenna in a satellite, wherein the multibeam antenna is configured to receive radio frequency user uplink data streams by generating a plurality of individual beams in a pattern configured to fully cover respective satellite's assigned ground coverage area.

7. The method according to claim 6, wherein the multibeam antenna is a space-fed lens phased array.

8. The method according to claim 1, wherein the method further comprises:
enabling the member satellites to communicate directly with terrestrial optical terminals not located within a terrestrial gateway.

9. The method according to claim 1, wherein the method further comprises:
communicating by the plurality of terrestrial gateways with satellites in a number of segments of optical frequencies via an equal number of optical terminal clusters, each optical terminal cluster comprising a plurality of optical laser terminals sufficient to individually link to all the satellites in view of a gateway region, and wherein said plurality of terrestrial gateways aggregate and process data streams and connect them to a terrestrial internet infrastructure.

10. The method according to claim 9, wherein a number of optical frequency segment and optical terminal clusters is four.

11. The method according to claim 9, wherein the optical laser terminals within each optical terminal cluster are distributed over an area in such a manner as to maintain sufficient spatial isolation to preclude interference between optical beams from all satellites in view of the gateway region.

12. The method according to claim 9, wherein the plurality of terrestrial gateways comprises airborne high-altitude relay platforms, wherein each of the airborne high-altitude relay platforms is configured to relay optical gateway communications with the satellites.

13. The method according to claim 12, wherein each optical terminal cluster comprises spatially isolated optical laser terminals to communicate with the airborne high-altitude relay platforms.

14. The method according to claim 1, wherein the method further comprises:
implementing terrestrial point-to-point optical communication using optical wideband frequency modulation laser links.

15. The method according to claim 1, wherein the method further comprises:
implementing airborne high-altitude relay platforms to provide optical path diversity mitigating adverse atmospheric conditions.

16. A system for ground-based point-to-point optical communication, the system comprising:
an origin node and a destination node, wherein the origin node is configured to communicate with the destination node through optical wideband frequency modulation laser links.

17. The system according to claim 16, wherein the system further comprises one or more relay nodes, wherein the one or more relay nodes is configured to relay the optical wideband frequency modulation laser links.

18. The system according to claim 16, wherein the origin node and the destination node are configured to convert radio frequency or baseband data streams using multiple adaptive coding digital modulation carriers into wideband frequency-modulated optical carrier links, and wherein the origin node and the destination node are further configured for converting wideband frequency-modulated optical carrier links into multiple radio frequency or baseband carriers for transmission to users.

19. The system according to claim 16, wherein the origin node is an airborne high-altitude platform or a drone.

20. The system according to claim 16, wherein either or both of the origin node and the destination node are configured to be installed and operated on a ship, an aircraft, or a mobile platform.

21. The system according to claim 16, wherein either or both of the origin node and the destination node are configured to be installed and operated on a moon, a planetary body, or in outerspace.

22. A space-fed lens antenna comprising:
a beamformer; and
an antenna radiator,
wherein the beamformer is configured to conduct space-fed beam forming at a higher radio frequency than the transmission or reception frequency of said space-fed lens antenna.
